(19) United States
(12) Patent Application Publication
(10) Pub. No.: US 2014/0108058 A1
(43) Pub. Date: Apr. 17, 2014

(54) Method and System to Determine Auto Insurance Risk

(71) Applicant: Agero, Inc., Medford, MA (US)

(72) Inventors: Julian J. Bourne, Weston, MA (US); Christopher Annibale, Malden, MA (US); Raj Behara, Andover, MA (US); Craig George Kenneth Copland, Beverly, MA (US); David P. Ferrick, Lexington, MA (US); Tod Farrell, Coppell, TX (US); Scott Nelson, Dallas, TX (US)

(73) Assignee: Agero, Inc., Medford, MA (US)

(21) Appl. No.: 14/051,210

(22) Filed: Oct. 10, 2013

Related U.S. Application Data
(60) Provisional application No. 61/712,656, filed on Oct. 11, 2012.
(60) Provisional application No. 61/716,283, filed on Oct. 19, 2012.
(60) Provisional application No. 61/787,172, filed on Mar. 15, 2013.

(51) Int. Cl. G06Q 40/08

(52) U.S. Cl. CPC G06Q 40/08
USPC 705/4

(57) ABSTRACT

A method for providing insurance underwriting using user-centric data includes receiving data reported from an application running on a telematics unit or a mobile device, matching the received data to known locations, and generating a score based on the reported data and the matched data. The reported data and the matched data are used to determine miles traveled. A valid trip is determined. A valid driver is determined to associate with the valid trip. A sum of valid trips is determined over a period of time. Location data for the mobile device or the telematics unit is determined. The location data is determined using network-based resources. The location data is determined using the mobile device or the telematics unit. The location data can be determined using a combination of network-based resources and the mobile device or the telematics unit. A change in location is categorized into a trip signature.

### CROSS-REFERENCE TO RELATED APPLICATIONS

This application claims priority to U.S. Provisional Application Ser. No. 61/712,656, filed on Oct. 11, 2012, U.S. Provisional Application Ser. No. 61/716,283, filed on Oct. 19, 2012, and U.S. Provisional Application Ser. No. 61/787,172, filed on Mar. 15, 2013, the entire disclosures of which are hereby incorporated herein by reference in their entireties.

### FIELD OF THE INVENTION

The present invention lies in the field of insurance underwriting. The present disclosure relates to determining insurance underwriting data using a mobile device.

### BACKGROUND OF THE INVENTION

Insurance companies have traditionally used broad variables to determine consumer risk profiles and insurance pricing. Examples of these variables include: home location, age, sex, annual vehicle miles driven, and driving record.

With usage-based insurance (UBI) and Pay As You Drive (PAYD) insurance programs, insurance companies are trying to improve the correlation of these variables to the quality of the driver. Safe drivers are considered a low for public liability, property damage, and other types of risk and are, therefore, less likely to incur a loss on their insurance policy.

On Board Diagnostics (OBD), e.g., OBDII, devices can be plugged into the OBDII port of a vehicle to capture vehicle data relating to mileage, hard braking, speeding, aggressive acceleration and other telematics data. In addition the device used to extract the vehicle data can also independently collect vehicle location and time of day.

Driverscore is a quantifiable mechanism used by insurance industry underwriters to categorize driver quality.

Usage-based insurance is used to analyze the data collected from these OBDII extraction devices to determine Driverscore. Driverscore may be a multi-variant linear or nonlinear regression curve. The weighting of variables is determined by coefficients, large coefficients being important variables, small coefficients relating to less important variables.

The trouble with using OBDII information is that the hardware of the device is expensive. Furthermore, a wireless connection is required to transmit driving behavior to a server. Attempts at mobile phone solutions that avoid hardware and wireless charges have failed to create a satisfactory user experience, in particular, due to rapid battery depletion, excess CPU usage, user initiated application activation, and the need to keep the application running at all times.

Prior art systems exclusively use Global Positioning System (GPS) information to obtain location information for underwriting purposes. However, extended use of GPS to provide location information causes rapid battery depletion. This rapid battery depletion may prevent users from adopting mobile device (e.g., smart phone) based data collection for the purposes of underwriting and calculating a risk profile for the user.

Thus, a need exists to overcome the problems with the prior art systems, designs, and processes as discussed above.

### SUMMARY OF THE INVENTION

The invention provides mileage tracking technology that overcome(s) the hereinafore-mentioned disadvantages of the heretofore-known devices and methods of this general type and that provide such features with a usage-based insurance application.

With the foregoing and other objects in view, there is provided, in accordance with the invention, a method for providing insurance underwriting using user-centric data. Data reported from an application running on a telematics unit or a mobile device is received. The received data is matched to known locations. A score is generated based on the reported data and the matched data.

In accordance with another mode of the invention, the reported data and the matched data is used to determine miles traveled.

In accordance with a further mode of the invention, a valid trip is determined.

In accordance with an added mode of the invention, a valid driver to associate with the valid trip is determined.

In accordance with an additional mode of the invention, a sum of valid trips over a period of time is determined.

In accordance with yet another mode of the invention, location data for the mobile device or the telematics unit is determined.

In accordance with yet a further mode of the invention, location data is determined using network-based resources.

In accordance with yet an added mode of the invention, location data is determined using the mobile device or the telematics unit.

In accordance with yet an additional mode of the invention, location data is determined using a combination of network-based resources and one of the mobile device and the telematics unit.

In accordance with again another mode of the invention, a change in location is categorized into a trip signature.

In accordance with again a further mode of the invention, location coordinates are determined for valid trip signatures.

In accordance with again an added mode of the invention, time stamps accompany each location coordinate.

In accordance with again an additional mode of the invention, a location profile is constructed by connecting the time stamps and location coordinates in chronological order.

In accordance with still another mode of the invention, location coordinates and time stamp data are calculated by, and received from, the telematics unit or mobile device.

In accordance with still a further mode of the invention, some location coordinates and time stamp data are excluded from overall mileage calculations.

In accordance with still an added mode of the invention, valid trip signatures are aggregated to provide a mileage traveled.

In accordance with still an additional mode of the invention, end-to-end integrity of the received data is ensured using at least one of authentication, encryption, and certification.

In accordance with still an additional mode of the invention, an identity of a driver is determined.

In accordance with still an additional mode of the invention, when a probability that the driver is driving on a valid route reaches a threshold, data collected for the route is used to calculate a driverscore.

In accordance with a concomitant feature of the invention, when a probability that the driver is driving on a valid route does not reach a threshold, data collected for the route is discarded.

Although the invention is illustrated and described herein as embodied in a usage-based insurance application, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a diagram illustrating a daily overview of vehicle usage according to an exemplary embodiment;

FIG. 2 is a diagram illustrating road mapping of a single trip according to an exemplary embodiment;

FIG. 3 is a diagram illustrating a route according to an exemplary embodiment;

FIG. 4 is a diagram illustrating a limited location sample according to an exemplary embodiment;

FIG. 5 is a block diagram of a system according to an exemplary embodiment; and

FIG. 6 is a block diagram of a system according to an exemplary embodiment.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Current insurance regulations base automobile insurance premiums for drivers on the projections of future mileage. These projections may prove to be accurate or inaccurate. Although insurance companies may require some supporting information, such as the customer's self-report on the number of miles driven to work, insurers do not have a reliable means to verify the customer's mileage. Insurers may request, but not require, mileage verification through odometer readings based on recent vehicle service reports (e.g., oil change invoices) or mileage-tracking technology.

The manual process for self-reporting by owners, by, for example, vehicle service reports, is fraught with errors and can lead to missed mileage reporting. This can result in an insurer raising a drivers' insurance rates for lack of a mileage report.

This invention describes the application of “mileage-tracking technology” as a solution to insurers' mileage reporting requests.

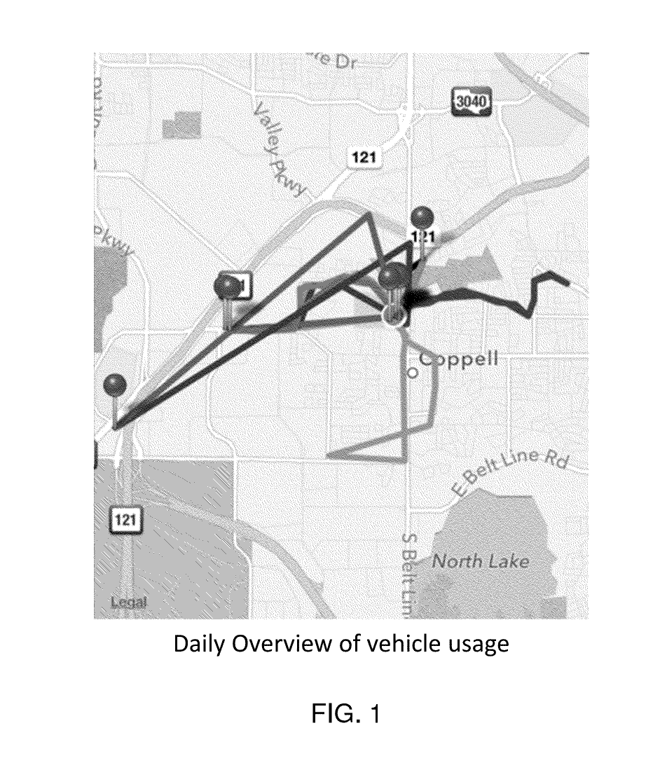

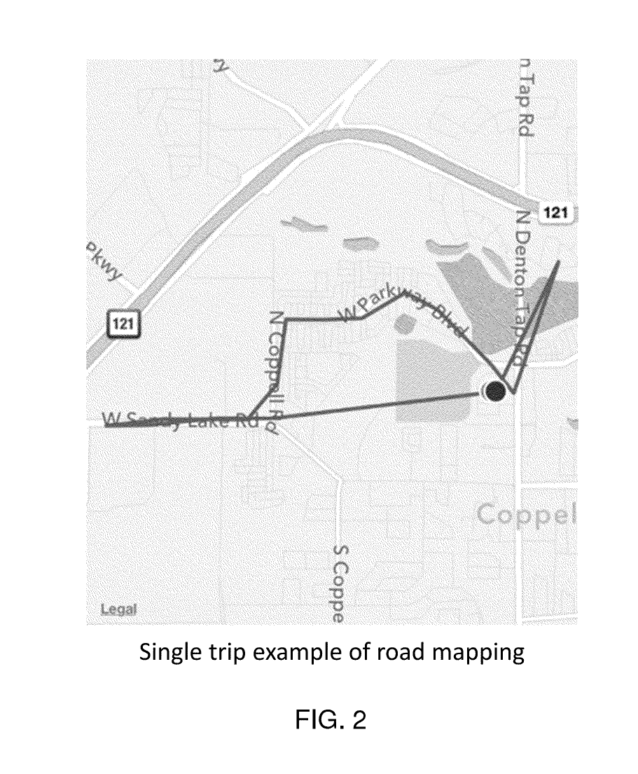

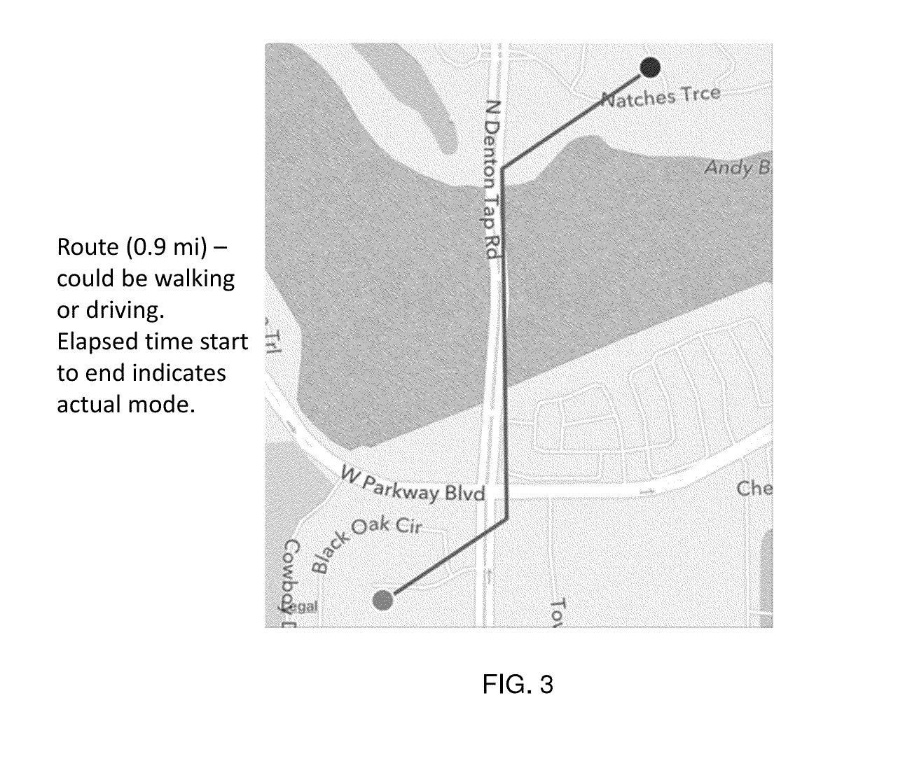

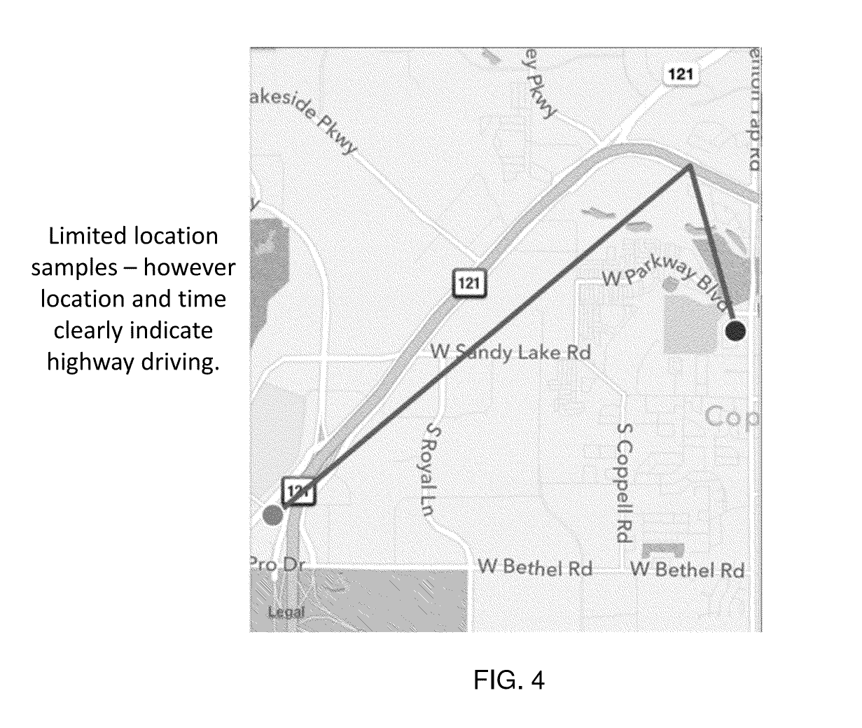

Described now are exemplary embodiments of the present invention. Referring now to the figures of the drawings in detail and first, particularly to FIG. 1, there is shown a first exemplary embodiment of a daily overview of vehicle usage. In this embodiment, each line represents a different trip taken by the user. FIG. 2 shows a road mapping of a single trip taken by the user. FIG. 3 shows one exemplary route taken by a user. In this example, the route is 0.9 miles. This route could be an example of a person who is walking or driving. The elapsed time, start to end, can indicate the actual mode of transportation. FIG. 4 shows an example of a limited location sample. In this example, however, location and time data can clearly be used to indicate highway driving. These vehicle usage examples will be applied to the systems and method of the invention as described below.

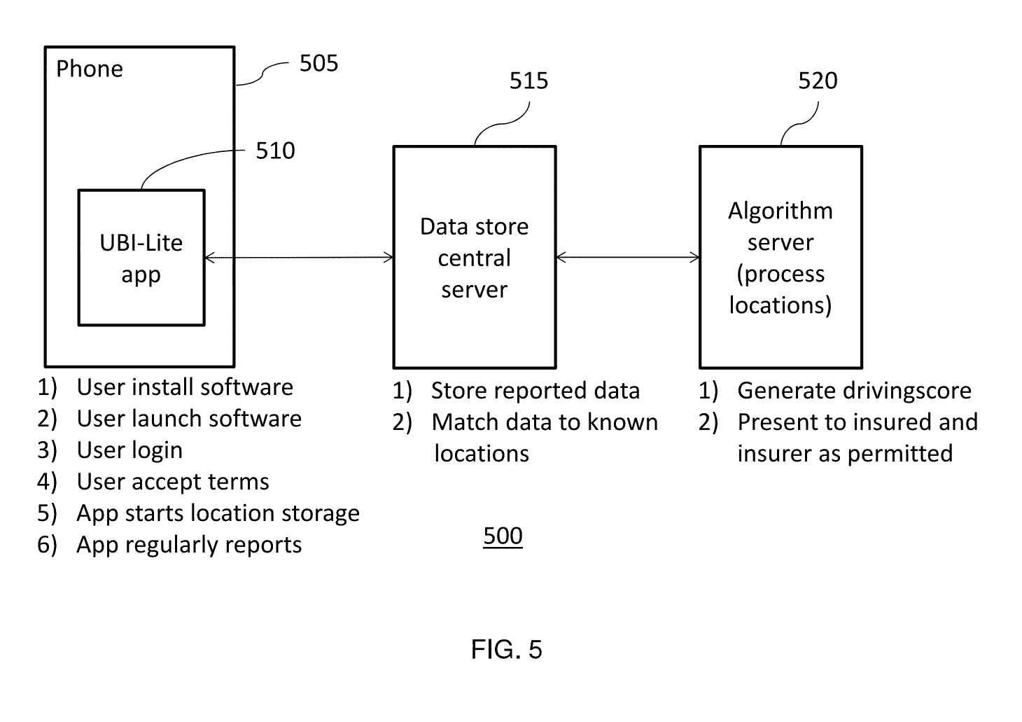

FIG. 5 is a diagram of an exemplary embodiment of systems and methods for underwriting a user with user-centric data by creating a driver fingerprint, determining a driverscore, and distinguishing whether the user is on a mode of transportation different from the vehicle insured. The system 500 includes a mobile device 505 running a UBI-Lite application 510, a data store central server 515, and an algorithm server 520 that is used to process locations. Mobile device 505 can be any of a variety of computing devices (e.g., cell phone, smartphone, handheld computer, Personal Digital Assistant (PDA), etc.) capable of running applications and allowing wireless two-way communications with one or more mobile communications networks, such as a cellular network, a satellite network (e.g., GPS), and/or a short range wireless network (e.g., WiFi).

At mobile device 505, the user installs application 510 software configured to create a driver fingerprint for the insured and determine a driverscore for that insured by distinguishing whether the user is on a mode of transportation different from the vehicle insured and even distinguishing whether or not the insured is a passenger. The user first launches the software, user logs into the application, and accepts the terms. The application 510 starts location storage. The application 510 regularly reports information to the data store central server 515 as described in further detail below.

The data store central server 515 stores reported data and matches data to known locations. From the reported and matched data, the algorithm server 520 generates a score, e.g., a driverscore, based on the reported data and the matched data. The algorithm server 520 presents the driverscore to the insured and the insurer as permitted.

Application 510 may operate in the background, functioning but not observable to the insured. Alternatively, the application 510 may also operate in the foreground where the application is observable by the user.

The mobile-based solution described herein avoids the need for expensive hardware and Machine-to-Machine (M2M) wireless charges. To adequately substitute a mobile device 505 for the OBDII device (not shown) there are certain important requirements:
determining location and changes in location using lower power;
determining if the user is a driver or passenger;
determining if the user is driving or on public transport;
determining if the user is driving, walking, or flying and filtering invalid data;
getting accurate mileage data without transmitting location data to the server;
pattern recognition determining behavior which is aimed at manipulating variables;
determining more accurate mileage when using course location information and heading; and
utilizing information for data analytics purposes; utilizing mobile phone network information to offer insurance telematics services.

In one exemplary embodiment, network or device location data is converted into driverscore variables. Valid trips are determined. Location data is layered on contextual and situational data and a valid driver is identified.

In one embodiment, location data is used to derive vehicle miles traveled. Once valid trips are determined, the distance between locations is computed to determine vehicle miles traveled. The sum of the trips is determined over a particular period of time.

Location data for a mobile device may be determined using a selection of methods. Global Positioning System (GPS), assisted GPS (network triangulation and GPS), WIFI location, user-defined (e.g., geo-locating address entered by a user), Cell ID (Cell of Origin—uses cell towers to triangulate; in cities, accuracy of location information can be determined within a few blocks or even within one block), and others. Location determination can be handled using network-based resources, on the mobile device, or using some combination of network and mobile device based resources. There is often a trade-off between quality of location and the power required to determine location.

In one exemplary embodiment, each change in location is categorized into a trip signature. For instance, a walking trip, a bicycling trip, a car ride, a train journey and a flight will each have different trip signatures. Variables recorded by the solution include, but are not limited to, distance traveled, speed, number of stops per distance traveled, acceleration, speed of stop, and location of travel (on train tracks or at airport).

For valid trip signatures, location latitude and longitude (or similar) coordinates are determined. Time stamps accompany each location coordinate. A picture of the location profile of a user can then be and is constructed by connecting the time stamps and location coordinates in chronological order. Aggregating trips with valid signatures provides a mileage traveled. In some circumstances the location and time stamp data may be calculated onboard and transmitted to the server for driverscore analysis. Some location and time data from some of these trip signatures can be excluded from overall mileage calculations. The exclusions and calculations of mileage may be undertaken “onboard” the device or “offboard” on the server. Some U.S. states, for privacy reasons, do not allow location data to be recorded.

In some cases, which may be determined by user preference, only select data elements may be transmitted. For example, in some states certain data elements, e.g., location, are not allowed to be transmitted. One or more data elements may be transmitted based upon user preference. For example, the user may choose to store, send, and/or extract only mileage information. The server-side algorithms, presumably at the insurer, then only take into account the elements the user has chosen to transmit, store, and/or submit, and can thus adjust policy factors accordingly.

In one embodiment, account security and validation mechanisms are implemented. For example, some insurers may require that at least one stream of data be authenticated, encrypted, and/or certified in order to ensure end-to-end integrity of the data.

Power Saving Method

To preserve mobile device battery power, the system chooses the lowest power location option when possible. GPS requires a large amount of processing power when used in a mobile device and, therefore, there is a correspondingly high usage of power. Wi-Fi, in contrast, can be used to obtain location information but requires much less processing power. Application 510 chooses which location-determining technology is to be used at any given time to minimize the amount of processing power needed to determine a location of mobile device 505. Therefore, if a Wi-Fi source is available, then the system will use the Wi-Fi-based location-determining technology instead of the GPS.

In this exemplary embodiment, Wi-Fi will be used to determine a location of mobile device 505. Power is conserved when using Wi-Fi as the location determining technology in various ways. For instance, location data need not be continually collected. In this exemplary embodiment, location data is gathered as infrequently as possible. Application 510 uses mobile device 505 to search for available Wi-Fi connections. This may be done periodically or when a “location-based event” occurs, e.g., using geo-fencing to determine when a user leaves a particular area, for example, when a user leaves a home or office.

When the mobile device is stationary, it is not necessary to determine location information repeatedly. A geo-fencing technology or internal force/orientation technology (e.g., gyroscopic devices) may be used to wake-up the mobile device when the device is moved from a stationary position to a traveling position.

A mobile device may hop between locations in a single building depending on the location technology utilized. The system sets a threshold beyond which a valid new trip is identified. Hopping location information is excluded from the usage and mileage information.

When available Wi-Fi connections are found, application 510 obtains Media Access Control (MAC) address and time stamp information. A database of Wi-Fi units that includes MAC addresses matched with location data corresponding to each MAC address can be accessed to provide location data for mobile device 505 without having to resort to GPS technology, which processing requires very little power and use of the mobile device. The determination of location data using the database can be handled by application 510 using the mobile device 505 or using an off-site server, e.g., server 515. Application 510 may communicate with server 515 using Wi-Fi or cellular resources. Each of these possibilities is less power- and bandwidth-intensive than constant use of GPS tracking or cell tower triangulation.

Repeatedly determining location on a valid trip causes unnecessary use and, therefore, battery drainage for the mobile device. In one exemplary embodiment, the system calculates a theoretical error from the respective location technologies for a specific trip and determines the optimum number of location hits, using the optimum location determining technology for the trip. In an exemplary embodiment, past driving behavior is compared to location coordinates and heading to calculate a probability that a user is embarked on a routine journey, thereby reducing the number of validating location hits needed.

In one exemplary embodiment, the system determines when the mobile device is connected to a power source. In this embodiment, location technology having greater accuracy may be utilized without adversely affecting the battery of the mobile device used to collect the location information.

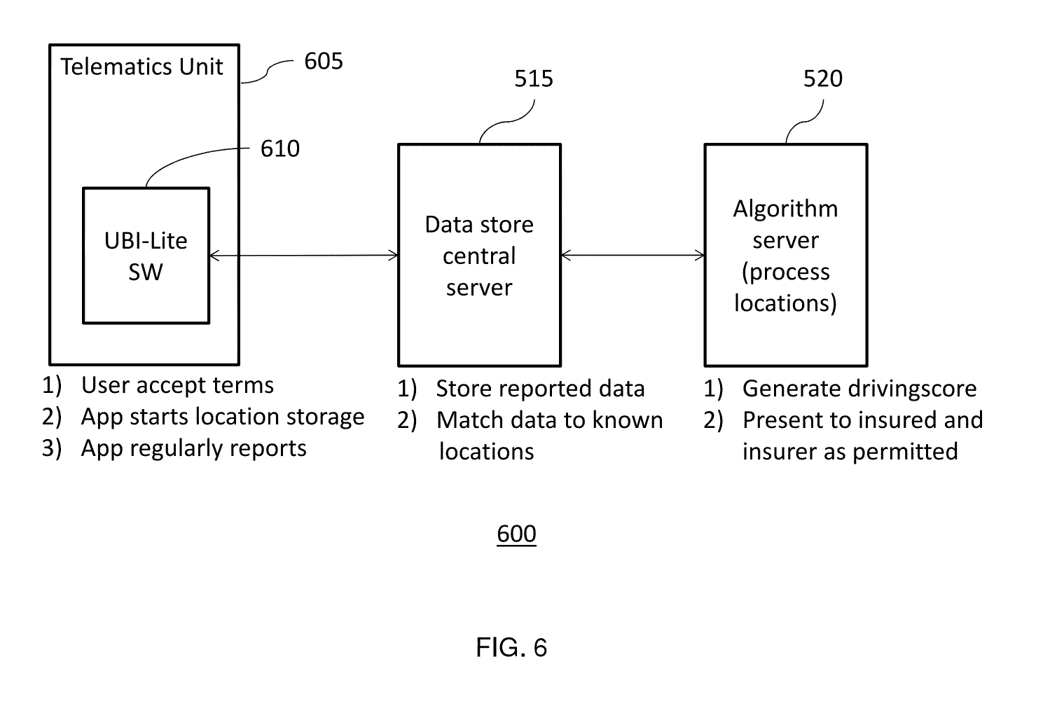

FIG. 6 is a diagram of an exemplary embodiment of systems and methods for underwriting a user with user-centric data by creating a driver fingerprint, determining a driverscore, and distinguishing whether the user is on a mode of transportation different from the vehicle insured. Features described with respect to the embodiment using the phone 505 and application 510 are also capable of being implemented in a device that is either built-in or user-removable. Application 610 is installed on telematics unit 605. Application 610 may be installed by the user or pre-installed on the telematics unit. Application 610 software is configured to create a driver fingerprint for the insured and determine a driverscore for that insured by distinguishing whether the user is on a mode of transportation different from the vehicle insured and even distinguishing whether or not the insured is a passenger. If the application 610 has been pre-installed, the user can accept terms and adjust data collection options through a user interface (not shown) associated with the server 510. The application 610 starts location storage. The application 610 regularly reports information to the data store central server 515.

Determine Road(s) Traveled on Route and Use with Black Spot or Other Data

When location information is garnered infrequently, and especially when GPS data is not used, the route does not exactly coincide with the roads actually traveled by the user. One reason for this is because Wi-Fi connections are, in most instances, located off of the roads traveled (e.g., in a store well off the main road of auto travel). Thus, the route appears to “cut corners” when overlayed with map information. These “cut corners” introduce error into the determination of the likely road on which a user is traveling. As more trips are taken along routine roads, more data points are able to be collected. As a result, over time, the route will more accurately correspond to actual roads when overlayed with map information. Given the vector of the road, the present location, and possible error along with other information, an automated way of determining roads traveled on a route can be determined. In addition to the vector, present location, and error information, information about a previous location point and the next location point is collected. Using this information (vector, present location, previous location, next location, error), the most likely road(s) can be predicted accurately factoring in speed and direction information. Collecting more data points during a trip allows the system to display a route that more accurately reflects the route taken by the user.

Once location data corresponds to actual roads on map overlay data, data collected by application 510 can be compared with accident “black spot” data for underwriting and driverscore purposes. Black spot data refers to information about a particular location's history of accidents or a cluster of accidents. Black spot data can be collected by roadside assistance providers (towing companies) who log the location of the accident and tow vehicle away from the black spot. Black spot data can also be obtained from telematics providers, emergency dispatchers, police, emergency responders, or other government agencies. Accidents can be classified by frequency or type in order to determine severity ratings, which can be a function of different variables such as driver-caused, weather-contributed, texting/cell use, etc. Historical weather data can be correlated to accident data to adjust the black spot distribution curve when local weather has adversely impacted the accident frequency or severity of a black spot. Black spot data can also be used to determine metrics for a route, for example, “accident per mile.”

This weighted accident history for each area or location is considered data on the black spots. A normal distribution curve of speed, hard braking, hard acceleration, etc. may be determined for each black spot. Driving characteristics, e.g. UBI data, of drivers can be determined as they encounter various black spots.

In one exemplary embodiment, a “driving calendar” may be constructed taking into account location, time, and distance driven information. The driverscore may be calculated by weighting the risks of driving by time of day, day of week, and time of year. The places through which the user drives and the number of miles driven may also be weighted according to the underwriter's preferences for risky or less risky locations. Assumptions about time spent in urban driving versus country driving may also be calculated.

The planned future location from calendars and commutes may be compared to the information collected or determined by the present system, e.g., UBI-Lite information, to increase the accuracy of driverscores, e.g., UBI-Lite driverscores, generated by the present system.

Additionally, this system can be used for safe travel coaching and parental awareness. This embodiment can be implemented by using the location or approximate location from the application of the system stored on the mobile device to report to the policy holder the location of the mobile device as compared to high-crime and/or high accident locations. Likewise, parents can set a notification area or check on an as-needed basis for obtaining a location of the mobile device.

Driver Fingerprint

To determine the identity of a driver, a “driver fingerprint” may be deduced. A driver fingerprint profile is a unique driving style attributed to a driver. Variables included in the driver fingerprint can be the style of driving, routes/locations typically driven, routine times of driving, and other idiosyncratic driving patterns, e.g., speed driven, acceleration, and/or deceleration on a particular route. Some driver fingerprint variables have a high likelihood of matching the pattern of driving on a segment of road perhaps not driven before. Over time, using machine learning techniques, a driver profile can be created and a probability that a certain person is driving can be determined with greater and greater accuracy. The system processes the information and data of users to create a unique fingerprint over time, which is part of the driverscore algorithm, e.g., the algorithm implemented by algorithm server 520. Thresholds for this probability are used. If the probability that the user is driving on a valid route reaches the threshold, the data collected for the user corresponding to the route is used in calculating the driverscore for the user. If the probability that the user is driving on a valid route does not reach the threshold, i.e., the data is unreliable, the data for that route is automatically discarded.

In one embodiment, driver authentication methods may be used. A driver can be authenticated in a variety of ways, including, but not limited to, machine vision and biometric technologies. In one embodiment, a driver is authenticated by using biometric techniques. For example, when a driver authenticates to a vehicle and that information is available to the device 505, 605, the device may log and/or send that information identifying the driver. In one embodiment, the driver can be identified in-action, e.g., the driver is validated to be the driver in the driver's seat using machine vision and/or biometric technologies such as vein-pattern-recognition.

To identify if a policy holder is a passenger, rather than a driver, the actual driver fingerprint is compared to an index of potential driver fingerprints. On occasions, two policyholders may be in the same car. As only one person can be driving, the driver fingerprint is matched to the actual driver fingerprint and the second passenger fingerprint is erased. Probabilistic inference, linear and non-linear decision boundaries, and other machine learning techniques may be used to calculate the probability that the driver signature matches the actual driver. The aggregate miles may include the probability calculation in cases of uncertainty. In one exemplary embodiment, the position of a mobile device can be compared to a datum point in the road. For instance, a phone in the pocket of the driver on a curve may appear at a longer radial curve than the radial curve of a mobile device in the pocket of a passenger (e.g., in a right-hand curve).

In addition to eliminating data from a driverscore for users who are passengers in a car, the present system is able to eliminate data for users who are passengers in a multitude of transportation options, e.g., trains, airplanes, taxis, buses, walking, cycling, etc. Information such as speed of travel, altitude, direction, and correlation with maps can be used to determine that a user is a passenger instead of a driver. For example, speed and altitude information can be used to determine whether a user is a passenger on an airplane. It can also be determined that a user is walking or cycling due to reduced speeds in comparison to other modes of transportation.

With respect to trains, in one embodiment, location latitude/longitude (lat/long) can be compared to map data to refine the location history. A train typically travels along vectors, e.g., a start point, an end-point, and a line in between. Thus, a probability can be determined to indicate if a user is traveling by train. By making this comparison, a handset that matches, over an extended period, the path of train tracks would be prioritized as a train-traveling mobile device and not as a driver-based mobile device. In another embodiment, the system utilizes a database of roads to determine whether a user is traveling by train. In this embodiment, if the location of travel is not on a road, the system infers that the user is traveling by train.

With respect to buses, these vehicles make stops much more frequently than private passenger vehicles. Further, public transportation route information exists and can be overlaid over maps. Thus, route, speed, and timing of stops can be used to determine a probability that a user is a passenger on a bus and is not driving the insured vehicle.

With respect to travel by a user in taxis, one metric that differentiates a taxi passenger from a driver is the density of the area. More specifically, if a user is in a dense metro area, that user has a greater likelihood of using taxis. In addition, using driver fingerprint information, it can be determined that the user is a passenger in different car with a different driver because the taxi driver fingerprint will be different from the insured's driver fingerprint. Similarly, if multiple taxis are taken by the user over time, each of the taxi drivers will have a different driver fingerprint, thereby increasing the probability/likelihood that the user is in a taxi.

A personal area network (PAN) or the Bluetooth device in the user's vehicle will have a device ID profile (DIP). The user's mobile phone may be paired with the car automatically and, therefore, determine that the user is in the car rather than in another form of transport. In addition, the driver identification, e.g., biometric, methods of the vehicle may also be used to determine that the user is, in fact, in the car and is a driver, rather than in another mode of transport.

In one embodiment, the system can account for professionals who drive for a living. Some examples of professionals who drive for a living are police officers, sanitation workers, and taxi drivers. Driving patterns for professionals working in the field would show unusual driving signatures/fingerprints, e.g., random destinations, excess mileage, and unusual shifts. The UBI-Lite system would place such users in a special category. The driver signature for these professions would be highlighted by the system as needing special treatment. In one embodiment, the system can extract personal driving from professional driving by isolating a most frequent location signature and the trips in between (e.g., home, work, gym, school) and excluding the seemingly random trips and locations from the calculation of driver score.

### Other Embodiments and Advantages

Although device 505, 605 has been described as a mobile device or telematics unit, any device can be configured to run the UBI-Lite application. For example, the UBI-Lite application can be run on a mobile device, an embedded device, and/or a bring your own device (BYOD) type device. In this context, BYOD includes any user device capable of running or accessing UBI-Lite application 510, 610.

In one embodiment, the UBI-Lite solution is implemented using in-memory processing. In another embodiment, the UBI-Lite solution is partially implemented using client-server cloud computing. In this embodiment, one or more of UBI-Lite application 510, 610, data store central server 515, and algorithm server 520 can be provided using a cloud-based solution.

In one embodiment, the entire UBI-Lite solution is provided via the cloud. In this embodiment, UBI-Lite application 510, 610 is accessed by device 505, 605 from the cloud. In addition, in this embodiment, data store central server 515 and algorithm server 520 are also provided using a cloud-based server solution.

Wireless companies may use data determined or collected using the present system, e.g., UBI-Lite data, to determine driverscores using only network locations. Lead generation business models may enable companies to sell auto insurance policies to their subscribers.

Driver profiles of the present system, e.g., UBI-Lite profiles, and Driverscore may be anonymously aggregated for data analytics purposed to compare underwriting best practice.

The present system can red flag behavior patterns that indicate misleading or avoidance behavior. If a user is suspected of misleading or avoidance behavior, the infrastructure can be set up to ask the network and mobile device for its location more frequently or at pre-determined times to verify the location of the mobile device. Additionally, a “trivia” question can be offered to the driver to confirm possession of the mobile device.

New variables may be added to the system to better predict driverscore.

Embodiments described herein provide significant advantages. Valid driverscore data is able to be captured. Automatic crash notification is provided through the user's mobile device. Location and other data is determined with negligible mobile device battery depletion. In addition, the present system facilitates individual pricing of insurance based on behavior, the ability to reduce fraud, implementation of the application at low cost, and flexibility to meet an insurer's underwriting model.

In each of the embodiments explained herein, it is understood that the user does not have the ability to change the status of the travel-information-collecting mobile application from an active data collection mode for driving to an inactive or off mode, the latter of which would indicate that the mobile user is not driving or is a passenger. This allows the insurance carrier the ability to see all movement of the user but it also introduces the possibility of the carrier using non-driver-related data in the insurance premium calculation. In an alternative exemplary embodiment, for example, for drivers/insureds having an excellent driving history, the driver can be given the ability to shut off the data collection mode when riding on public transportation or when being a passenger. This, however, increases the risk of missing bad driving behavior when the user does not report fully or truthfully.

In one embodiment, a log of when the device is disabled or disconnected is kept. This log can be verifiable by the service provider or middle party implementing server 515 or the insurer such that the disablement or disconnect information can be taken into account in policy factors.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for providing insurance underwriting using user-centric data, which comprises:
receiving data reported from an application running on a telematics unit or a mobile device;
matching the received data to known locations; and
generating a score based on the reported data and the matched data.

2. The method of claim 1, which further comprises using the reported data and the matched data to determine miles traveled.

3. The method of claim 1, which further comprises determining a valid trip.

4. The method of claim 3, which further comprises determining a valid driver to associate with the valid trip.

5. The method of claim 3, which further comprises determining a sum of valid trips over a period of time.

6. The method of claim 1, which further comprises determining location data for the mobile device or the telematics unit.

7. The method of claim 6, which further comprises determining the location data using network-based resources.

8. The method of claim 6, which further comprises determining the location data using the mobile device or the telematics unit.

9. The method of claim 6, which further comprises determining the location data using a combination of network-based resources and one of the mobile device and the telematics unit.

10. The method of claim 6, which further comprises categorizing a change in location into a trip signature.

11. The method of claim 10, which further comprises determining location coordinates for valid trip signatures.

12. The method of claim 11, wherein time stamps accompany each location coordinate.

13. The method of claim 12, which further comprises constructing a location profile by connecting the time stamps and the location coordinates in chronological order.

14. The method of claim 12, wherein location coordinates and time stamp data are calculated by and received from the telematics unit or the mobile device.

15. The method of claim 12, which further comprising excluding some of the location coordinates and the time stamp data from overall mileage calculations.

16. The method of claim 10, which further comprising aggregating valid trip signatures to provide a mileage traveled.

17. The method of claim 1, which further comprising ensuring end-to-end integrity of the received data using at least one of authentication, encryption, and certification.

18. The method of claim 1, which further comprises determining an identity of a driver.

19. The method of claim 18, which further comprising using data collected for the route to calculate a driverscore when a probability that the driver is driving on a valid route reaches a threshold.

20. The method of claim 18, which further comprising discarding data collected for the route when a probability that the driver is driving on a valid route does not reach a threshold.
